(19) United States
(12) Patent Application Publication
(10) Pub. No.: US 2008/0122838 A1
(43) Pub. Date: May 29, 2008

(54) Methods and Systems for Referencing a Primitive Located in a Spatial Index and in a Scene Index

(76) Inventors: Russell Dean Hoover, Rochester, MN (US); Eric Oliver Mejdrich, Rochester, MN (US); Robert Allen Shearer, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/535,837

(22) Filed: Sep. 27, 2006

(51) Int. Cl. G06T 17/00

(52) U.S. Cl. 345/420

(57) ABSTRACT

Embodiments of the invention provide methods and systems to reduce the amount of space necessary to store a spatial index. According to embodiments of the invention, a spatial index may store pointers to information defining primitives which are located within bounding volumes defined by leaf nodes in the spatial index. The pointers may be smaller in size in contrast to information which defines the primitives, and the pointers may point to locations within a scene graph which contains information defining the primitives. Therefore, by storing pointers to primitives in the spatial index rather than the information which defines the primitives, the amount of space required to store the spatial index may be reduced.

### BACKGROUND OF THE INVENTION

1. Field of the Invention

Embodiments of the invention generally relate to the field of image processing.

2. Description of the Related Art

The process of rendering two-dimensional images from three-dimensional scenes is commonly referred to as image processing. As the modern computer industry evolves image processing evolves as well. One particular goal in the evolution of image processing is to make two-dimensional simulations or renditions of three-dimensional scenes as realistic as possible. One limitation of rendering realistic images is that modern monitors display images through the use of pixels.

A pixel is the smallest area of space which can be illuminated on a monitor. Most modern computer monitors will use a combination of hundreds of thousands or millions of pixels to compose the entire display or rendered scene. The individual pixels are arranged in a grid pattern and collectively cover the entire viewing area of the monitor. Each individual pixel may be illuminated to render a final picture for viewing.

One technique for rendering a real world three-dimensional scene onto a two-dimensional monitor using pixels is called rasterization. Rasterization is the process of taking a two-dimensional image represented in vector format (mathematical representations of geometric objects within a scene) and converting the image into individual pixels for display on the monitor. Rasterization is effective at rendering graphics quickly and using relatively low amounts of computational power; however, rasterization suffers from some drawbacks. For example, rasterization often suffers from a lack of realism because it is not based on the physical properties of light, rather rasterization is based on the shape of three-dimensional geometric objects in a scene projected onto a two-dimensional plane. Furthermore, the computational power required to render a scene with rasterization scales directly with an increase in the complexity of the scene to be rendered. As image processing becomes more realistic, rendered scenes also become more complex. Therefore, rasterization suffers as image processing evolves, because rasterization scales directly with complexity.

Another technique for rendering a real world three-dimensional scene onto a two-dimensional monitor using pixels is called ray tracing. The ray tracing technique traces the propagation of imaginary rays, rays which behave similar to rays of light, into a three-dimensional scene which is to be rendered onto a computer screen. The rays originate from the eye(s) of a viewer sitting behind the computer screen and traverse through pixels, which make up the computer screen, towards the three-dimensional scene. Each traced ray proceeds into the scene and may intersect with objects within the scene. If a ray intersects an object within the scene, properties of the object and several other contributing factors are used to calculate the amount of color and light, or lack thereof, the ray is exposed to. These calculations are then used to determine the final color of the pixel through which the traced ray passed.

The process of tracing rays is carried out many times for a single scene. For example, a single ray may be traced for each pixel in the display. Once a sufficient number of rays have been traced to determine the color of all of the pixels which make up the two-dimensional display of the computer screen, the two-dimensional synthesis of the three-dimensional scene can be displayed on the computer screen to the viewer.

Ray tracing typically renders real world three-dimensional scenes with more realism than rasterization. This is partially due to the fact that ray tracing simulates how light travels and behaves in a real world environment, rather than simply projecting a three-dimensional shape onto a two-dimensional plane as is done with rasterization. Therefore, graphics rendered using ray tracing more accurately depict on a monitor what our eyes are accustomed to seeing in the real world.

Furthermore, ray tracing also handles increases in scene complexity better than rasterization as scenes become more complex. Ray tracing scales logarithmically with scene complexity. This is due to the fact that the same number of rays may be cast into a scene, even if the scene becomes more complex. Therefore, ray tracing does not suffer in terms of computational power requirements as scenes become more complex as rasterization does.

One major drawback of ray tracing is the large number of calculations, and thus processing power, required to render scenes. This leads to problems when fast rendering is needed. For example, when an image processing system is to render graphics for animation purposes such as in a game console. Due to the increased computational requirements for ray tracing it is difficult to render animation quickly enough to seem realistic (realistic animation is approximately twenty to twenty-four frames per second).

Therefore, there exists a need for more efficient techniques and devices to perform ray tracing.

### SUMMARY OF THE INVENTION

Embodiments of the present invention generally provide methods and apparatus for performing ray tracing.

According to one embodiment of the invention a method of referencing primitives in a three-dimensional scene is provided. The method generally comprising creating a scene graph containing information defining at least one primitive located within the three-dimensional scene; and creating a spatial index with internal nodes having branches to other nodes and at least one full leaf node, wherein the internal nodes and the at least one full leaf node define bounding volumes of the three-dimensional scene, and wherein the at least one full leaf node contains at least one pointer to the information defining the at least one primitive contained in the scene graph.

According to another embodiment of the invention a computer readable medium containing a program is provided. The program when executed, performs operations generally comprising: creating a scene graph containing information defining at least one primitive located within the three-dimensional scene; and creating a spatial index with internal nodes having branches to other nodes and at least one full leaf node, wherein the internal nodes and the at least one full leaf node define bounding volumes of the three-dimensional scene, and wherein the at least one full leaf node contains at least one pointer to the information defining the at least one primitive contained in the scene graph.

According to another embodiment of the invention an image processing system is provided. The system generally comprising a scene graph containing information defining at least one primitive located within the three-dimensional scene; and a spatial index with internal nodes having branches to other nodes and at least one full leaf node, wherein the internal nodes and the at least one full leaf node define bounding volumes of the three-dimensional scene, and wherein the at least one full leaf node contains at least one pointer to the primitive in the scene graph.

### BRIEF DESCRIPTION OF THE DRAWINGS

FIG. 1 illustrates a multiple core processing element, according to one embodiment of the invention.

FIG. 2 illustrates a multiple core processing element network, according to one embodiment of the invention.

FIG. 3 is an exemplary three-dimensional scene to be rendered by an image processing system, according to one embodiment of the invention.

FIGS. 4A-4C illustrate a two-dimensional space to be rendered by an image processing system and a corresponding spatial index created by an image processing system, according to one embodiment of the invention.

FIG. 5 illustrates an exemplary scene graph, according to one embodiment of the invention.

FIG. 6 illustrates an exemplary spatial index, according to one embodiment of the invention.

### DETAILED DESCRIPTION OF THE PREFERRED EMBODIMENTS

Embodiments of the invention provide methods and systems to reduce the amount of space necessary to store a spatial index. According to embodiments of the invention, a spatial index may store pointers to information defining primitives which are located within bounding volumes defined by leaf nodes in the spatial index. The pointers may be smaller in size in contrast to information which defines the primitives, and the pointers may point to locations within a scene graph which contains information defining the primitives. Therefore, by storing pointers to primitives in the spatial index rather than the information which defines the primitives, the amount of space required to store the spatial index may be reduced.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary Processor Layout and Communications Network

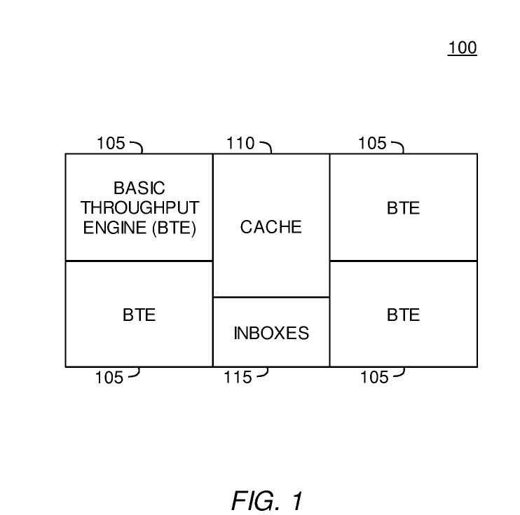

FIG. 1 illustrates a multiple core processing element 100, according to one embodiment of the invention. The multiple core processing element 100 includes a plurality of basic throughput engines 105 (BTEs). A BTE 105 may contain a plurality of processing threads and a core cache (e.g., an L1 cache). The processing threads located within each BTE may have access to a shared multiple core processing element cache 110 (e.g., an L2 cache).

The BTEs 105 may also have access to a plurality of inboxes 115. The inboxes 115 may be memory mapped address space. The inboxes 115 may be mapped to the processing threads located within each of the BTEs 105. Each thread located within the BTEs may have a memory mapped inbox and access to all of the other memory mapped inboxes 115. The inboxes 115 make up a low latency and high bandwidth communications network used by the BTEs 105.

The BTEs may use the inboxes 115 as a network to communicate with each other and redistribute data processing work amongst the BTEs. For some embodiments, separate outboxes may be used in the communications network, for example, to receive the results of processing by BTEs 105. For other embodiments, inboxes 115 may also serve as outboxes, for example, with one BTE 105 writing the results of a processing function directly to the inbox of another BTE 105 that will use the results.

The aggregate performance of an image processing system may be tied to how well the BTEs can partition and redistribute work. The network of inboxes 115 may be used to collect and distribute work to other BTEs without corrupting the shared multiple core processing element cache 110 with BTE communication data packets that have no frame to frame coherency. An image processing system which can render many millions of triangles per frame may include many BTEs 105 connected in this manner.

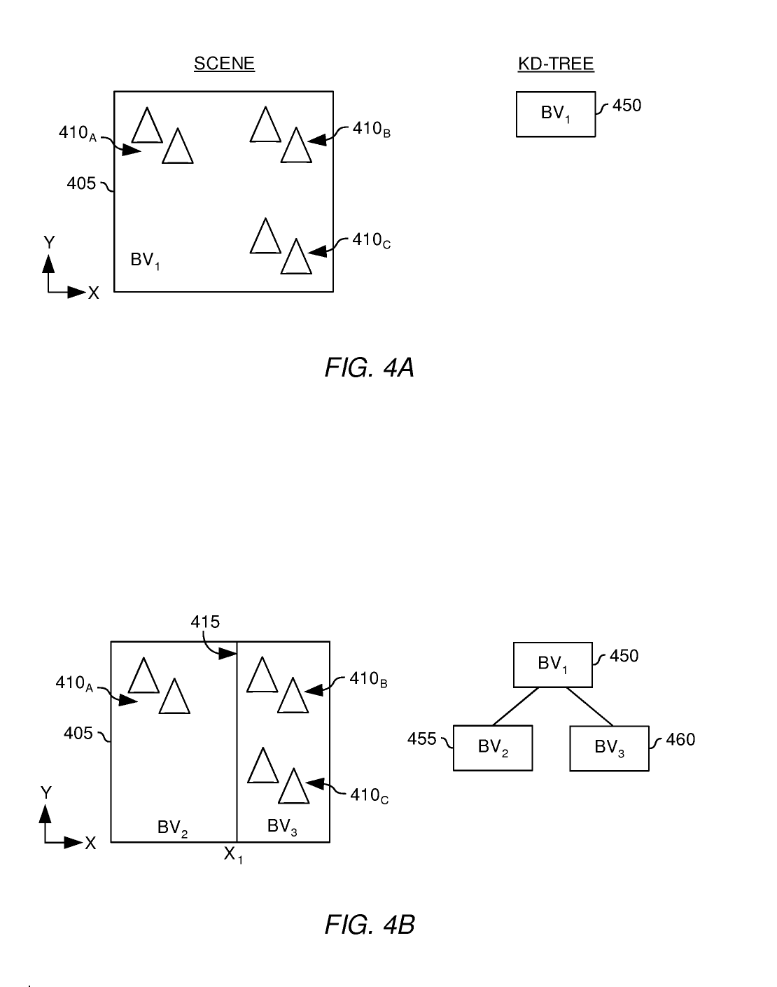

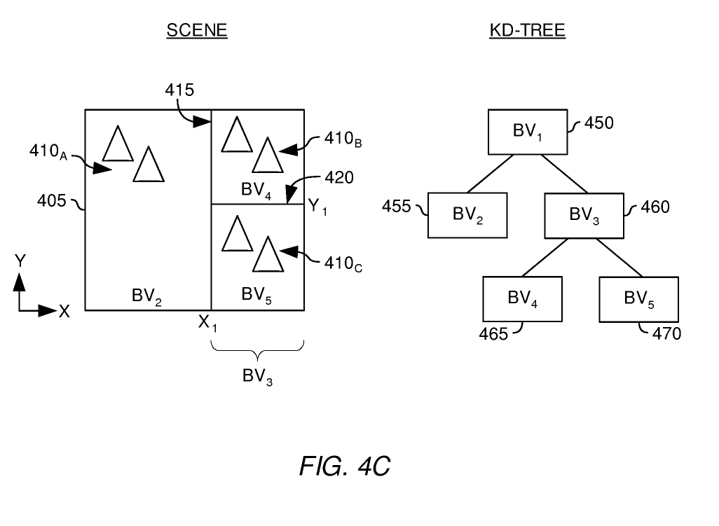

In one embodiment of the invention, the threads of one BTE 105 may be assigned to a workload manager. An image processing system may use various software and hardware components to render a two-dimensional image from a three-dimensional scene. According to one embodiment of the invention, an image processing system may use a workload manager to traverse a spatial index with a ray issued by the image processing system. A spatial index, as described further below with regards to FIG. 4, may be implemented as a tree type data structure used to partition a relatively large three-dimensional scene into smaller bounding volumes. An image processing system using a ray tracing methodology for image processing may use a spatial index to quickly determine ray-bounding volume intersections. In one embodiment of the invention, the workload manager may perform ray-bounding volume intersection tests by using the spatial index.

In one embodiment of the invention, other threads of the multiple core processing element BTEs 105 on the multiple core processing element 100 may be vector throughput engines. After a workload manager determines a ray-bounding volume intersection, the workload manager may issue (send), via the inboxes 115, the ray to one of a plurality of vector throughput engines. The vector throughput engines may then determine if the ray intersects a primitive contained within the bounding volume. The vector throughput engines may also perform operations relating to determining the color of the pixel through which the ray passed.

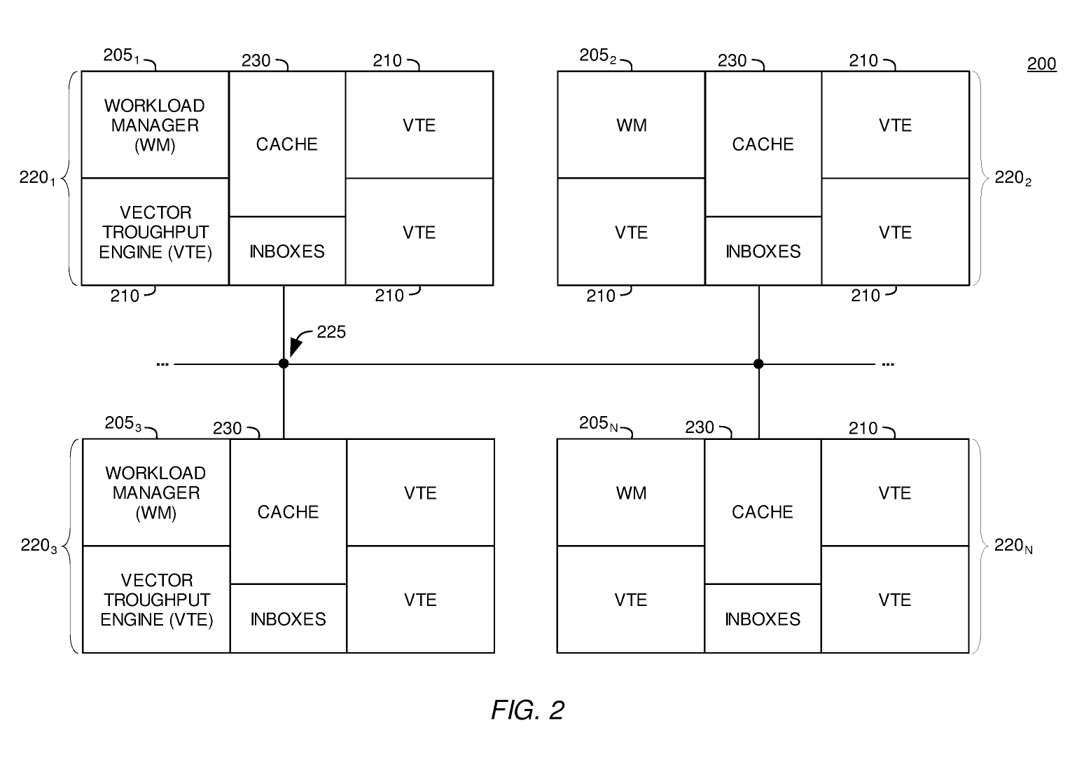

FIG. 2 illustrates a network of multiple core processing elements 200, according to one embodiment of the invention. FIG. 2 also illustrates one embodiment of the invention where the threads of one of the BTEs of the multiple core processing element 100 is a workload manager 205. Each multiple core processing element 220_{1-N} in the network of multiple core processing elements 200 may contain one workload manager 205_{1-N}, according to one embodiment of the invention. Each processor 220 in the network of multiple core processing elements 200 may also contain a plurality of vector throughput engines 210, according to one embodiment of the invention.

The workload managers 220_{1-N} may use a high speed bus 225 to communicate with other workload managers 220_{1-N} and/or vector throughput engines 210 of other multiple core processing elements 220, according to one embodiment of the invention. Each of the vector throughput engines 210 may use the high speed bus 225 to communicate with other vector throughput engines 210 or the workload managers 205. The workload manager processors 205 may use the high speed bus 225 to collect and distribute image processing related tasks to other workload manager processors 205, and/or distribute tasks to other vector throughput engines 210. The use of a high speed bus 225 may allow the workload managers 205_{1-N} to communicate without affecting the caches 230 with data packets related to workload manager 205 communications.

### An Exemplary Three-Dimensional Scene

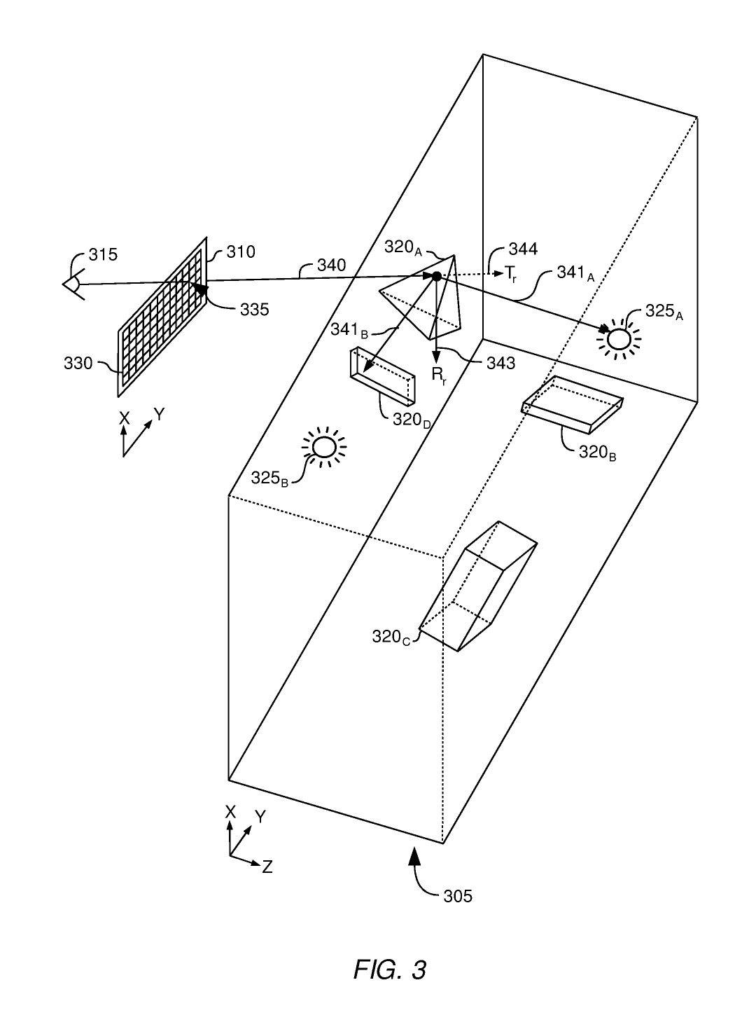

FIG. 3 is an exemplary three-dimensional scene 305 to be rendered by an image processing system. Within the three-dimensional scene 305 may be objects 320. The objects 320 in FIG. 3 are of different geometric shapes. Although only four objects 320 are illustrated in FIG. 3, the number of objects in a typical three-dimensional scene may be more or less. Commonly, three-dimensional scenes will have many more objects than illustrated in FIG. 3.

As can be seen in FIG. 3 the objects are of varying geometric shape and size. For example, one object in FIG. 3 is a pyramid 320_{A}. Other objects in FIG. 3 are boxes 320_{B-D}. In many modern image processing systems objects are often broken up into smaller geometric shapes (e.g., squares, circles, triangles, etc.). The larger objects are then represented by a number of the smaller simple geometric shapes. These smaller geometric shapes are often referred to as primitives.

Also illustrated in the scene 305 are light sources 325_{A-B}. The light sources may illuminate the objects 320 located within the scene 305. Furthermore, depending on the location of the light sources 325 and the objects 320 within the scene 305, the light sources may cause shadows to be cast onto objects within the scene 305.

The three-dimensional scene 305 may be rendered into a two-dimensional picture by an image processing system. The image processing system may also cause the two-dimensional picture to be displayed on a monitor 310. The monitor 310 may use many pixels 330 of different colors to render the final two-dimensional picture.

One method used by image processing systems to rendering a three-dimensional scene 320 into a two-dimensional picture is called ray tracing. Ray tracing is accomplished by the image processing system “issuing” or “shooting” rays from the perspective of a viewer 315 into the three-dimensional scene 320. The rays have properties and behavior similar to light rays.

One ray 340, that originates at the position of the viewer 315 and traverses through the three-dimensional scene 305, can be seen in FIG. 3. As the ray 340 traverses from the viewer 315 to the three-dimensional scene 305, the ray 340 passes through a plane where the final two-dimensional picture will be rendered by the image processing system. In FIG. 3 this plane is represented by the monitor 310. The point the ray 340 passes through the plane, or monitor 310, is represented by a pixel 335.

As briefly discussed earlier, most image processing systems use a grid 330 of thousands (if not millions) of pixels to render the final scene on the monitor 310. Each individual pixel may display a different color to render the final composite two-dimensional picture on the monitor 310. An image processing system using a ray tracing image processing methodology to render a two-dimensional picture from a three-dimensional scene will calculate the colors that the issued ray or rays encounters in the three-dimensional scene. The image processing scene will then assign the colors encountered by the ray to the pixel through which the ray passed on its way from the viewer to the three-dimensional scene.

The number of rays issued per pixel may vary. Some pixels may have many rays issued for a particular scene to be rendered. In which case the final color of the pixel is determined by the each color contribution from all of the rays that were issued for the pixel. Other pixels may only have a single ray issued to determine the resulting color of the pixel in the two-dimensional picture. Some pixels may not have any rays issued by the image processing system, in which case their color may be determined, approximated or assigned by algorithms within the image processing system.

To determine the final color of the pixel 335 in the two-dimensional picture, the image processing system must determine if the ray 340 intersects an object within the scene. If the ray does not intersect an object within the scene it may be assigned a default background color (e.g., blue or black, representing the day or night sky). Conversely, as the ray 340 traverses through the three-dimensional scene the ray 340 may strike objects. As the rays strike objects within the scene the color of the object may be assigned the pixel through which the ray passes. However, the color of the object must be determined before it is assigned to the pixel.

Many factors may contribute to the color of the object struck by the original ray 340. For example, light sources within the three-dimensional scene may illuminate the object. Furthermore, physical properties of the object may contribute to the color of the object. For example, if the object is reflective or transparent, other non-light source objects may then contribute to the color of the object.

In order to determine the effects from other objects within the three-dimensional scene, secondary rays may be issued from the point where the original ray 340 intersected the object. For example, one type of secondary ray may be a shadow ray. A shadow ray may be used to determine the contribution of light to the point where the original ray 340 intersected the object. Another type of secondary ray may be a transmitted ray. A transmitted ray may be used to determine what color or light may be transmitted through the body of the object. Furthermore, a third type of secondary ray may be a reflected ray. A reflected ray may be used to determine what color or light is reflected onto the object.

As noted above, one type of secondary ray may be a shadow ray. Each shadow ray may be traced from the point of intersection of the original ray and the object, to a light source within the three-dimensional scene 305. If the ray reaches the light source without encountering another object before the ray reaches the light source, then the light source will illuminate the object struck by the original ray at the point where the original ray struck the object.

For example, shadow ray 341_{A} may be issued from the point where original ray 340 intersected the object 320_{A}, and may traverse in a direction towards the light source 325_{A}. The shadow ray 341_{A} reaches the light source 325_{A} without encountering any other objects 320 within the scene 305. Therefore, the light source 325_{A} will illuminate the object 320_{A} at the point where the original ray 340 intersected the object 320_{A}.

Other shadow rays may have their path between the point where the original ray struck the object and the light source blocked by another object within the three-dimensional scene. If the object obstructing the path between the point on the object the original ray struck and the light source is opaque, then the light source will not illuminate the object at the point where the original ray struck the object. Thus, the light source may not contribute to the color of the original ray and consequently neither to the color of the pixel to be rendered in the two-dimensional picture. However, if the object is translucent or transparent, then the light source may illuminate the object at the point where the original ray struck the object.

For example, shadow ray 341_{B} may be issued from the point where the original ray 340 intersected with the object 320_{A}, and may traverse in a direction towards the light source 325_{B}. In this example, the path of the shadow ray 341_{B} is blocked by an object 320_{D}. If the object 320_{D} is opaque, then the light source 325_{B} will not illuminate the object 320_{A} at the point where the original ray 340 intersected the object 320_{A}. However, if the object 320_{D} which the shadow ray is translucent or transparent the light source 325_{B} may illuminate the object 320_{A} at the point where the original ray 340 intersected the object 320_{A}.

Another type of secondary ray is a transmitted ray. A transmitted ray may be issued by the image processing system if the object with which the original ray intersected has transparent or translucent properties (e.g., glass). A transmitted ray traverses through the object at an angle relative to the angle at which the original ray struck the object. For example, transmitted ray 344 is seen traversing through the object 320_{A} which the original ray 340 intersected.

Another type of secondary ray is a reflected ray. If the object with which the original ray intersected has reflective properties (e.g. a metal finish), then a reflected ray will be issued by the image processing system to determine what color or light may be reflected by the object. Reflected rays traverse away from the object at an angle relative to the angle at which the original ray intersected the object. For example, reflected ray 343 may be issued by the image processing system to determine what color or light may be reflected by the object 320_{A} which the original ray 340 intersected.

The total contribution of color and light of all secondary rays (e.g., shadow rays, transmitted rays, reflected rays, etc.) will result in the final color of the pixel through which the original ray passed.

### An Exemplary Kd-Tree

One problem encountered when performing ray tracing is determining quickly and efficiently if an issued ray intersects any objects within the scene to be rendered. One methodology known by those of ordinary skill in the art to make the ray intersection determination more efficient is to use a spatial index. A spatial index divides a three-dimensional scene or world into smaller volumes (smaller relative to the entire three-dimensional scene) which may or may not contain primitives. An image processing system can then use the known boundaries of these smaller volumes to determine if a ray may intersect primitives contained within the smaller volumes. If a ray does intersect a volume containing primitives, then a ray intersection test can be run using the trajectory of the ray against the known location and dimensions of the primitives contained within that volume. If a ray does not intersect a particular volume then there is no need to run ray-primitive intersection tests against the primitives contained within that volume. Furthermore, if a ray intersects a bounding volume which does not contain primitives then there is no need to run ray-primitive intersections tests against that bounding volume. Thus, by reducing the number of ray-primitive intersection tests which may be necessary, the use of a spatial index greatly increases the performance of a ray tracing image processing system. Some examples of different spatial index acceleration data structures are octrees, k dimensional Trees (kd-Trees), and binary space partitioning trees (BSP trees). While several different spatial index structures exist, for ease of describing embodiments of the present invention, a kd-Tree will be used in the examples to follow. However, those skilled in the art will readily recognize that embodiments of the invention may be applied to any of the different types of spatial indexes.

A kd-Tree uses axis aligned bounding volumes to partition the entire scene or space into smaller volumes. That is, the kd-Tree may divide a three-dimensional space encompassed by a scene through the use of splitting planes which are parallel to known axes. The splitting planes partition a larger space into smaller bounding volumes. Together the smaller bounding volumes make up the entire space in the scene. The determination to partition (divide) a larger bounding volume into two smaller bounding volumes may be made by the image processing system through the use of a kd-tree construction algorithm.

One criterion for determining when to partition a bounding volume into smaller volumes may be the number of primitives contained within the bounding volume. That is, as long as a bounding volume contains more primitives than a predetermined threshold, the tree construction algorithm may continue to divide volumes by drawing more splitting planes. Another criterion for determining when to partition a bounding volume into smaller volumes may be the amount of space contained within the bounding volume. Furthermore, a decision to continue partitioning the bounding volume may also be based on how many primitives may be intersected by the plane which creates the bounding volume.

The partitioning of the scene may be represented by a binary tree structure made up of nodes, branches and leaves. Each internal node within the tree may represent a relatively large bounding volume, while the node may contain branches to sub-nodes which may represent two relatively smaller partitioned volumes resulting after a partitioning of the relatively large bounding volume by a splitting plane. In an axis-aligned kd-Tree, each internal node may contain only two branches to other nodes. The internal node may contain branches (i.e., pointers) to one or two leaf nodes. A leaf node is a node which is not further sub-divided into smaller volumes and contains pointers to primitives. An internal node may also contain branches to other internal nodes which are further sub-divided. An internal node may also contain the information needed to determine along what axis the splitting plane was drawn and where along the axis the splitting plane was drawn.

### Exemplary Bounding Volumes

FIGS. 4A-4C illustrate a two-dimensional space to be rendered by an image processing system and a corresponding kd-tree. For simplicity, a two-dimensional scene is used to illustrate the building of a kd-Tree, however kd-Trees may also be used to represent three-dimensional scenes. In the two-dimensional illustration of FIGS. 4A-4C splitting lines are illustrated instead of splitting planes, and bounding areas are illustrated instead of bounding volumes as would be used in a three-dimensional structure. However, one skilled in the art will quickly recognize that the concepts may easily be applied to a three-dimensional scene containing objects.

FIG. 4A illustrates a two-dimensional scene 405 containing primitives 410 to be rendered in the final picture to be displayed on a monitor 310. The largest volume which represents the entire volume of the scene is encompassed by bounding volume 1 (BV₁). In the corresponding kd-Tree this may be represented by the top level node 450, also known as the root or world node. In one embodiment of an image processing system, an image processing system may continue to partition bounding volumes into smaller bounding volumes when the bounding volume contains, for example, more than two primitives. As noted earlier the decision to continue partitioning a bounding volume into smaller bounding volumes may be based on many factors, however for ease of explanation in this example the decision to continue partitioning a bounding volume is based only on the number of primitives. As can be seen in FIG. 4A, BV₁ contains six primitives, therefore kd-Tree construction algorithm may partition BV₁ into smaller bounding volumes.

FIG. 4B illustrates the same two-dimensional scene 405 as illustrated in FIG. 4A. However, in FIG. 4B the tree construction algorithm has partitioned BV₁ into two smaller bounding volumes BV₂ and BV₃. The partitioning of BV₁, was accomplished, by drawing a splitting plane SP₁ 415 along the x-axis at point x₁. This partitioning of BV₁ is also reflected in the kd-Tree as the two nodes 455 and 460, corresponding to BV₂ and BV₃ respectively, under the internal or parent node BV₁ 450. The internal node representing BV₁ may now store information such as, but not limited to, pointers to the two nodes beneath BV₁ (e.g., BV₂ and BV₃), along which axis the splitting plane was drawn (e.g., x-axis), and where along the axis the splitting plane was drawn (e.g., at point x₁).

The kd-Tree construction algorithm may continue to partition bounding volume BV₃ because it contains more than the predetermined threshold of primitives (e.g., more than two primitives). However, the kd-Tree construction algorithm may not continue to partition bounding volume BV₂, because bounding volume BV₂ contains less than or equal to the number of primitives (e.g., only two primitives 410_{A}). Nodes which are not partitioned or sub-divided any further, such as BV₂, are referred to as leaf nodes.

FIG. 4C illustrates the same two-dimensional scene 405 as illustrated in FIG. 4B. However, in FIG. 4C the kd-Tree construction algorithm has partitioned BV₃ into two smaller bounding volumes BV₄ and BV₅. The kd-construction algorithm has partitioned BV₃ using a partitioning plane along the y-axis at point y₁. Since BV₃ has been partitioned into two sub-nodes it may now be referred to as an internal node. The partitioning of BV₃ is also reflected in the kd-Tree as the two leaf nodes 465 and 470, corresponding to BV₄ and BV₅ respectively. BV₄ and BV₅ are leaf nodes because the volumes they represent are not further divided into smaller bounding volumes. The two leaf nodes, BV₄ and BV₅, are located under the internal node BV₃ which represents the bounding volume which was partitioned in the kd-Tree.

The internal node representing BV₃ may store information such as, but not limited to, pointers to the two leaf nodes (i.e., BV₄ and BV₅), along which axis the splitting plane was drawn (i.e., y-axis), and where along the axis the splitting plane was drawn (i.e., at point y₁).

The kd-Tree construction algorithm may now stop partitioning the bounding volumes because all bounding volumes located within the scene contain less than or equal to the maximum predetermined number of primitives which may be enclosed within a bounding volume. The leaf nodes may contain pointers to the primitives which are enclosed within the bounding volumes each leaf represents. For example, leaf node BV₂ may contain pointers to primitives 410_{A}, leaf node BV₄ may contain pointers to primitives 410_{B}, and leaf node BV₅ may contain pointers to primitives 410_{C}.

A ray tracing image processing system may use the workload manager 205 to traverse the spatial index (kd-Tree). Traversing the kd-Tree may include selecting a branch to a node on a lower level (sub-node) of the kd-Tree to take or proceed to in order to determine if the ray intersects any primitives contained within the sub-node. A workload manager 205 may use the coordinates and trajectory of an issued ray to traverse or navigate through the kd-Tree. By executing ray-bounding volume intersection tests, the workload manager 205 may determine if the ray intersects a plane of the bounding volumes represented by nodes within the kd-Tree structure. If the ray intersects a bounding volume which contains only primitives (i.e., a leaf node), then the workload manager 205 may send the ray and associated information to a vector throughput engine 210 for ray-primitive intersection tests. A ray-primitive intersection test may be executed to determine if the ray intersects the primitives within the bounding volume. This methodology results in fewer ray-primitive intersection tests needed to determine if a ray intersects an object within the scene, in comparison to running ray-primitive intersection tests for a ray against each primitive contained within the scene.

The resulting kd-Tree structure, or other spatial index structure, may be stored in a processor cache 230. The kd-Tree and the size of corresponding data which comprises the kd-Tree may be optimized for storage in a processor cache 230. The storage of the kd-Tree in a processor cache 230 may allow a workload manager 205 to traverse the kd-Tree with a ray that has been issued by the image processing system without having to retrieve the kd-Tree from memory every time a ray is issued by the image processing system.

### Referencing a Primitive Located within a Spatial Index and a Scene Graph

In graphics applications, a three-dimensional scene may have many objects. One method of keeping track of all the objects in a three-dimensional scene may be to use a scene graph or a scene index. The scene graph may contain information which defines the objects located within the three-dimensional scene. The scene graph may use a hierarchical structure (e.g., a tree) to index or order the objects.

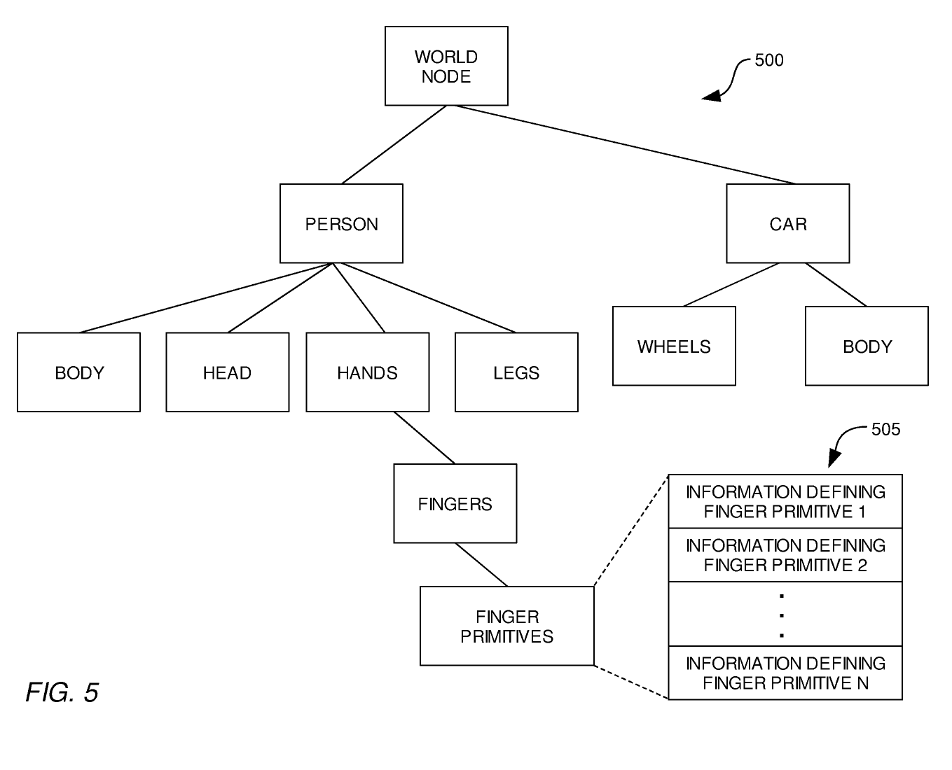

For example, FIG. 5 illustrates an exemplary scene graph 500, according to one embodiment of the invention. As illustrated, the scene graph 500 may contain a world node which represents the entire three-dimensional scene. On lower levels of the scene graph 500 may be nodes which represent finer levels of detail in relation to objects located throughout the three-dimensional scene. The scene graph may be stored, for example, in system memory or in a memory cache of a processing element.

For example, as illustrated in FIG. 5, a three-dimensional scene may have two objects, for example a car and a person. As illustrated in FIG. 5, the scene graph 500 contains two nodes beneath the world node corresponding to the person object and the car object. Furthermore, the car object may have a body and wheels. Therefore, the scene graph 500 may have two nodes beneath the car object node corresponding to the body of the car and the wheels of the car.

The person object may have, for example, a head, a body, hands and legs. Therefore, the nodes beneath the person object corresponding to the body, the head, the hands and the legs. Furthermore, the hands in the three-dimensional scene may have fingers, and therefore a fingers node in the scene graph 500 is illustrated. Beneath the fingers node, a node is illustrated in scene graph 500 which contains primitives which correspond to the fingers. As illustrated in FIG. 5, this node may contain information 505 which defines the primitives. For example information which defines the primitives may include location, the size and the orientation of the finger primitives. Information defining a single primitive may be located within the fingers primitive node, or information defining a plurality of primitives (e.g. N finger primitives) may be located within the fingers primitive node. Furthermore, other nodes on different levels of the scene graph may also contain information defining primitives as well.

As described above, a three-dimensional scene may also be represented by a spatial index. A spatial index may represent a partitioning of the three-dimensional scene into bounding volumes. These bounding volumes may facilitate the traversal of a ray through the three-dimensional scene, and thus the determination of whether or not the ray intersects primitives located within the three-dimensional scene. The spatial index may have nodes which represent a bounding volume encompassing portions of the three-dimensional scene. For example, the spatial index may include a world node representing a volume which encompasses the entire three-dimensional scene. Furthermore, the spatial index may have internal nodes which have branches to nodes on lower levels which encompass smaller bounding volumes. The spatial index may also have leaf nodes which do not have branches to nodes on lower levels.

The leaf nodes may be of two types. For example, a leaf node may be an empty leaf node or a full leaf node. An empty leaf node may be a leaf node corresponding to a bounding volume in the three-dimensional scene which does not contain any primitives, and a full leaf node may be a leaf node corresponding to a bounding volume in the three-dimensional scene which contains one or more primitives.

According to embodiments of the invention, information which defines the primitives contained within the bounding volume corresponding to a full leaf node may be stored in the full leaf node. When a ray is traversed to a full leaf node, ray-primitive intersection tests may be performed to determine if the ray intersects a primitive within the bounding volume corresponding to the full leaf node. In order to perform the ray-primitive intersection tests, information which defines the primitive is necessary. Individually, the information which defines a single primitive may not require a large/significant amount of memory space. However, in some circumstances in a three-dimensional scene millions of primitives may be necessary to construct all of the objects. Therefore, storing the information defining all of the primitives in the spatial index may require a substantial amount of storage. In certain circumstances it may be desirable to reduce the amount of information required to define the primitives located within the three-dimensional scene.

According to one embodiment of the invention, in contrast to storing information defining primitives in both the scene graph and the spatial index, the scene graph may contain information defining the primitives (e.g., primitive location, size, orientation, etc.) and the spatial index may contain pointers to the information defining the primitives in the scene graph. The pointers to the information defining the primitives may require less storage space than the information defining the primitives. Therefore, by storing pointers to information defining primitives in a full leaf node in contrast to storing information defining the primitives in a full leaf node, the storage space needed to identify all primitives contained within the bounding volume corresponding to the full leaf node may be reduced. By extension, the total amount of storage space necessary to store a spatial index may be reduced when the full leaf nodes contain pointers to information defining primitives in contrast to information defining the primitives. Furthermore, by storing pointers to information defining the primitives in the leaf nodes, the information defining the primitives is not duplicated in both the scene graph and the spatial index and, thus, the storage space necessary to represent the overall three-dimensional scene (e.g., the scene graph and the spatial index) may be reduced.

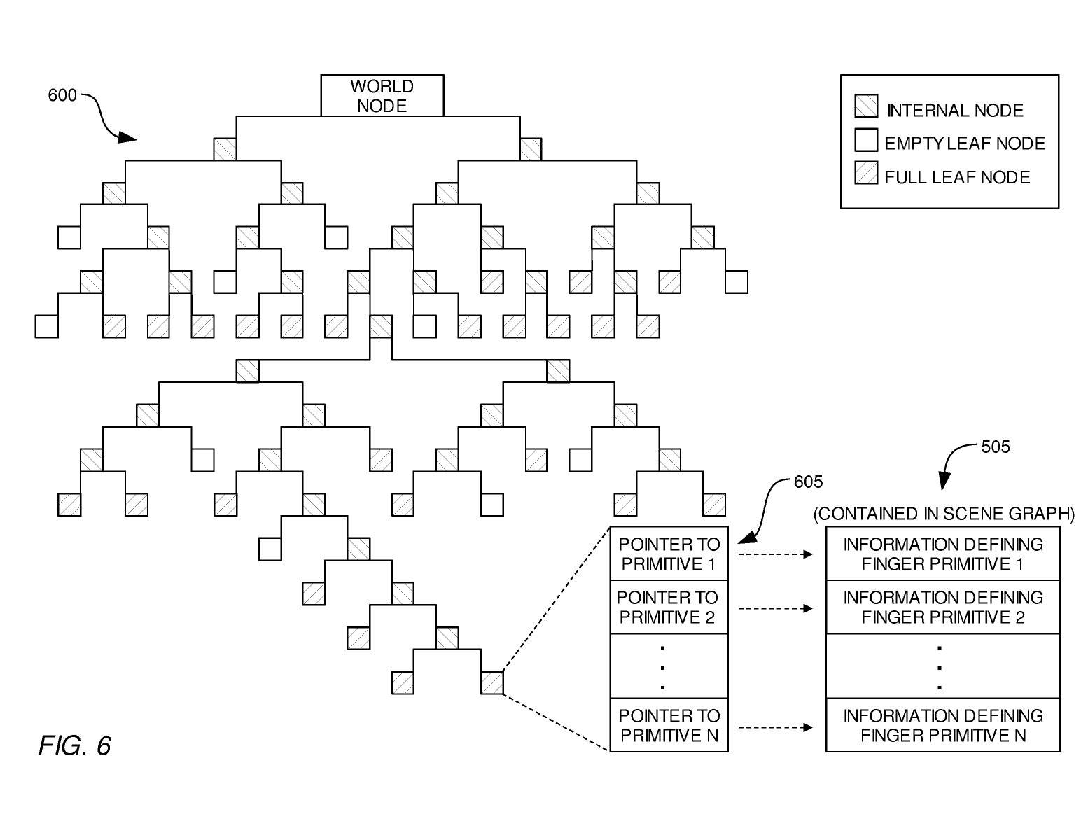

One example of a spatial index 600 containing leaf nodes which store pointers to information defining primitives is illustrated in FIG. 6. A list of pointers to information defining primitives may be stored in each full leaf node of the spatial index 600. For example, a list of pointers to information defining primitives 605 in a full leaf node of the spatial index 600 is illustrated in FIG. 6. The list of pointers to information defining primitives 605 illustrated in FIG. 6 may point, for example, to information defining the finger primitives 505 in the scene graph 500 illustrated in FIG. 5. According to one embodiment of the invention, the list of pointers to information defining primitives 605 may be a linked list (e.g., a singly-linked list, doubly-linked list, or circularly-linked list).

According to one embodiment of the invention, the list of pointers to information defining primitives 605 may contain as many pointers as there are primitives in the bounding volume defined by the leaf node. For example, as illustrated in FIG. 6 a leaf node may correspond to a bounding volume which contains a number (N) of primitives. Therefore, according to one embodiment of the invention, the list of pointers to information defining primitives 605 may contain N pointers.

According to other embodiments of the invention, the list of pointers to information defining primitives may contain a number of pointers smaller than the number of primitives in the bounding volume defined by the leaf node. In which case, the leaf node may contain a number of pointers to information defining a first portion of the primitives contained within the bounding volume and information which defines the remaining primitives contained within the bounding volume that do not have corresponding pointers.

As described with reference to FIG. 6, information defining the primitives (e.g., location, orientation, size, etc.) may be contained within a scene index. Therefore, according to one embodiment of the invention, when a processing element (e.g., a vector throughput engine 210) needs to execute ray-primitive intersection tests based upon a traversal of a ray to a leaf node (e.g., by a workload manager 205) the processing element may use the list of pointers to information defining primitives to obtain the information defining the primitives from the scene graph.

According to one embodiment of the invention, once all of the information defining each of the primitives contained within the bounding volume defined by the leaf node has been obtained from the scene graph, the vector throughput engine 210 may perform ray-primitive intersection tests to determine if the ray intersects any of the primitives contained within the bounding volume.

According to another embodiment of the invention, the vector throughput engine may commence ray-primitive intersection tests as the information defining each of the primitives is obtained from the scene graph. That is, when sufficient information to execute a single ray-primitive intersection test has been obtained from the scene graph the vector throughput engine 210 may commence ray-primitive intersection tests. Thus, the vector throughput engine 210 may perform ray-primitive intersection tests as information defining primitives is obtained form the scene graph.

### CONCLUSION

By using pointers to information defining primitives in a spatial index in contrast to storing information defining the primitives in the spatial index, the amount of space required to store a spatial index may be reduced. The pointers to information defining primitives may be located within leaf nodes of the spatial index. The pointers may point to information defining the primitives located within a scene graph. Furthermore, the pointers may require less storage space in contrast to the information which defines the primitives. Therefore, by storing pointers in the spatial index in contrast to storing the information which defines primitives in the spatial index, the amount of space required to store the spatial index may be reduced.

While the foregoing is directed to embodiments of the present invention, other and further embodiments of the invention may be devised without departing from the basic scope thereof, and the scope thereof is determined by the claims that follow.

What is claimed is:

1. A method of referencing primitives in a three-dimensional scene, comprising:
creating a scene graph containing information defining at least one primitive located within the three-dimensional scene; and
creating a spatial index with internal nodes having branches to other nodes and at least one full leaf node, wherein the internal nodes and the at least one full leaf node define bounding volumes of the three-dimensional scene, and wherein the at least one full leaf node contains at least one pointer to the information defining the at least one primitive contained in the scene graph.

2. The method of claim 1, wherein the information defining the primitive comprises at least one of a location of the primitive, an orientation of the primitive, or a boundary of the primitive.

3. The method of claim 1, further comprising:
for a full leaf node defining a bounding volume in the three-dimensional scene containing a plurality of primitives, creating a list of pointers to information defining a first portion of the plurality of primitives contained in the scene graph.

4. The method of claim 3, wherein the list of pointers is a linked list.

5. The method of claim 3, wherein first portion of the plurality of primitives comprises all of the primitives contained in the full leaf node.

6. The method of claim 1, further comprising:
generating a ray into the three-dimensional scene;
traversing the spatial index by taking branches from the internal nodes until the full leaf node is reached, wherein branches are taken based on whether the ray intersects the bounding volumes defined by the nodes;
using the pointer to retrieve information defining the primitive from the scene graph; and
determining if the ray hits the primitive using the information defining the primitive.

7. A computer readable medium containing a program which, when executed, performs operations comprising:
creating a scene graph containing information defining at least one primitive located within the three-dimensional scene; and
creating a spatial index with internal nodes having branches to other nodes and at least one full leaf node, wherein the internal nodes and the at least one full leaf node define bounding volumes of the three-dimensional scene, and wherein the at least one full leaf node contains at least one pointer to the information defining the at least one primitive contained in the scene graph.

8. The computer readable medium of claim 7, wherein the information defining the primitive comprises at least one of a location of the primitive, an orientation of the primitive, or a boundary of the primitive.

9. The computer readable medium of claim 7, wherein the operations further comprise:
for a full leaf node defining a bounding volume in the three-dimensional scene containing a plurality of primitives, creating a list of pointers to information defining a first portion of the plurality of primitives contained in the scene graph.

10. The computer readable medium of claim 9, wherein the list is a linked list.

11. The computer readable medium of claim 9, wherein first portion of the plurality of primitives comprises all of the primitives contained in the full leaf node.

12. The computer readable medium of claim 7, wherein the operations further comprise:
generating a ray into the three-dimensional scene;
traversing the spatial index by taking branches from the internal nodes until the full leaf node is reached, wherein branches are taken based on whether the ray intersects the bounding volumes defined by the nodes;
using the pointer to retrieve information defining the primitive from the scene graph; and
determining if the ray hits the primitive using the information defining the primitive.

13. An image processing system, comprising:
a scene graph containing information defining at least one primitive located within the three-dimensional scene; and
a spatial index with internal nodes having branches to other nodes and at least one full leaf node, wherein the internal nodes and the at least one full leaf node define bounding volumes of the three-dimensional scene, and wherein the at least one full leaf node contains at least one pointer to the primitive in the scene graph.

14. The system of claim 13, wherein the information defining the primitive comprises at least one of a location of the primitive, an orientation of the primitive, or a boundary of the primitive.

15. The system of claim 13, wherein spatial index further comprises a full leaf node defining a bounding volume in the three-dimensional scene containing a plurality of primitives, and wherein the full leaf node contains a list of pointers to information defining a first portion of the plurality of primitives in the scene graph.

16. The system of claim 15, wherein the list is a linked list.

17. The system of claim 15, wherein first portion of the plurality of primitives comprises all of the primitives contained in the full leaf node.

18. The system of claim 13, further comprising a first processing element configured to perform operations comprising:
generating a ray into the three-dimensional scene;
traversing the spatial index by taking branches from the internal nodes until the full leaf node is reached, wherein branches are taken based on whether the ray intersects the bounding volumes defined by the nodes; and
using the pointer to retrieve information defining the primitive from the scene graph.

19. The system of claim 18, wherein the first processing element is further configured to perform the operation comprising:
determining if the ray hits the primitive using the information defining the primitive.
